(19) United States
(12) Patent Application Publication
(10) Pub. No.: US 2025/0207996 A1
(43) Pub. Date: Jun. 26, 2025

(54) METHOD AND DEVICE FOR DETERMINING AN IMAGING QUALITY OF AN OPTICAL SYSTEM TO BE TESTED

(71) Applicant: TRIOPTICS GmbH, Wedel (DE)

(72) Inventors: Aiko RUPRECHT, Wedel (DE); Benjamin STAUSS, Wedel (DE); Patrik ERICHSEN, Wedel (DE); Daniel WINTERS, Wedel (DE); Lasse SCHROEDTER, Wedel (DE)

(73) Assignee: TRIOPTICS GmbH, Wedel (DE)

(21) Appl. No.: 18/851,938

(22) PCT Filed: Mar. 27, 2023
(86) PCT No.: PCT/EP2023/057833

§ 371 Date: Sep. 27, 2024

(30) Foreign Application Priority Data
Mar. 31, 2022 (DE) 10 2022 107 686.5

(51) Int. Cl. G01M 11/02

(52) U.S. Cl. CPC G01M 11/0257; G01M 11/0207

(57) ABSTRACT

A method for determining an imaging quality of an optical system to be tested is presented. The method comprises a step of capturing an optical wavefront profile in a measurement plane behind an exit pupil of the optical system, a step of ascertaining a partial optical wavefront profile for each subaperture of a plurality of subapertures of the measurement plane using the wavefront profile, and a step of determining a partial optical imaging quality for each of the subapertures using the ascertained partial optical wavefront profiles.

### PRIOR ART

The invention discloses a method and a device for determining an imaging quality of an optical system to be tested according to the subject-matter of the independent claims.

For applications and systems in the field of augmented reality (AR) and virtual reality (VR), the imaging quality within an eye box, i.e., within a movement range of an eye, is an important quality parameter. The eye box can be understood as a three-dimensional volume in which the pivot point of the eye must be located so that it is able to fully perceive a displayed image exclusively through eye movements or rotation.

U.S. Pat. No. 10,277,893 B1 describes a camera system that is arranged behind a VR headset to be tested. In this case, a measuring task is achieved by mechanically moving a measuring device, such as a camera, which is arranged behind the exit pupil of the test object. By means of the camera system, the eye movements of a user are mechanically recreated.

Regarding this background, the approach presented here presents an improved method and an improved device for determining an imaging quality of an optical system to be tested according to the main claims. Advantageous ebodiments and improvements of the device specified in the independent claim are possible via the measures set out in the dependent claims.

The approach presented here presents a simple and time-efficient way to determine an imaging quality of an optical system to be tested, without using a scanning process or a mechanical grid, for example. Instead, a plurality of measurement parameters can advantageously be obtained from a single measurement, as a result of which it is, for example, also possible to achieve low error susceptibility.

A method for determining an imaging quality of an optical system to be tested is presented, wherein the method comprises a step of capturing an optical wavefront profile in a measurement plane behind an exit pupil of the optical system, a step of dividing or segmenting the measurement plane into a plurality of subapertures, a step of ascertaining a partial optical wavefront profile for each subaperture of a plurality of subapertures of the measurement plane using the wavefront profile, a step of determining a partial optical imaging quality for each of the subapertures using the ascertained partial optical wavefront profiles, as a result of which a statement about the distribution of the imaging quality across the entire measurement plane can be made.

The optical system to be tested may, for example, be realized as data glasses, as optics of data glasses, or as an eyeglass lens, which can be realized in conjunction with an AR/VR device that is usually worn close to the human eye. The method can advantageously measure and check the imaging quality of the optical system to be tested within an eye box. For example, corresponding measurement results can be used to check or improve the optical system. The optical wavefront profile can represent a profile of the optical wavefront in the measurement plane or an image of optical waves on the measurement plane. The optical waves can propagate from the exit pupil of the optical system toward the measurement plane. The wavefront profile may depend on a structure of the optical system to be tested, such a structure may, for example, influence a beam path of the optical system to be tested. The imaging quality of the optical system to be tested can thus be deduced from a characteristic of the wavefront profile. The imaging quality can relate to at least one characteristic variable of an optical transfer function of the optical system to be tested. The subapertures may, for example, be designed as segment surfaces of the measurement plane, which together can form the measurement plane or a portion of the measurement plane that is located within the eye box. There is the possibility that the subapertures partially overlap, since, in particular in optical systems for AR/VR applications, the generally large exit pupil is generated by multiplying the generally small entrance pupil. The partial wavefront profiles together, i.e., considered as a whole, can thus form the captured wavefront profile of the measurement plane. The partial wavefront profiles of the subapertures can thus be ascertained by segmenting the wavefront profile. The subapertures may, for example, have dimensions of less than 10 mm². For example, the subapertures may be rectangular, circular or square. The subapertures may be the same size. The dimensions of the subapertures may be in the order of magnitude of a human eye pupil. The partial imaging qualities can relate to at least one characteristic variable of an optical transfer function of a portion of the optical system to be tested that can be assigned to the corresponding subapertures. Advantageously, the method can determine the imaging quality at any position of the eye pupil within the eye box with a so-called one-shot measurement, which can significantly reduce the time required for the measurement. For example, the imaging qualities of the subapertures within the measurement plane can be used to make a statement about how the imaging quality parameter is distributed across the measurement plane.

Alternatively, the method described herein can likewise be applied to other near-eye optical systems outside the application area of virtual or augmented reality. Examples of such systems include bifocal contact lenses or progressive eyeglass lenses. Such optics have the property that the exit aperture is divided into different zones, wherein each zone can be assigned a different refractive power. Even for such near-eye optical systems, a distribution of the imaging quality can thus be determined by means of the method described herein. The subapertures, which can be assigned to the zones of different refractive power, can have different dimensions and do not have to be evenly distributed over the measurement plane.

An example of a bifocal contact lens is disclosed in US20210382323 A1. The lens described in this document has a zone for distance vision, which is located in the upper lens region, and a zone for near vision, which is located in the lower lens region. The lens often has an outer ring structure for stabilization while the eye is moving. The use of the near range and far range of the contact lens is realized by offsetting the contact lens relative to the eye pupil. According to one embodiment, this can be reproduced metrologically by differently positioned subapertures.

According to one embodiment, in the step of capturing, the wavefront profile in the measurement plane can be captured using a wavefront sensor. The wavefront sensor may, for example, be realized as part of a testing device with which the method can be carried out. Advantageously, the wavefront sensor can capture light rays guided through the optical system to be tested and can provide the captured light rays for evaluation. The wavefront sensor may, for example, be realized as a well known Shack-Hartmann sensor.

A division rule used for dividing the measurement plane into the plurality of subapertures in the step of dividing can be specified for the measurement plane. Advantageously, the step of dividing makes it possible to simply determine the imaging quality at different positions within the eye box, wherein the individual partial apertures may partially overlap. In addition, mechanical rasterization or scanning of the measurement plane can be dispensed with.

In addition, the method may comprise a step of defining a measurement volume prior to the step of capturing, wherein the measurement plane can represent a cross-sectional area of the measurement volume. A size of the measurement volume can correspond to a size of an eye box used. By defining a suitably large and suitably placed measurement volume, it is possible to determine the imaging quality of a portion of the optical system to be tested that is relevant to an intended later application of the optical system to be tested.

According to one embodiment, the method may furthermore comprise a step of determining a further partial optical imaging quality for each further subaperture of a plurality of further subapertures of a further measurement plane behind the exit pupil of the optical system. In the step of determining, the imaging quality can furthermore be determined using the further partial imaging qualities. Advantageously, the measurement plane and the further measurement plane can be linearly spaced apart along an optical axis of the optical system to be tested. For example, the optical system to be tested can have a plurality of measurement planes, the distances between which can be realized evenly, for example. Advantageously, the further partial imaging qualities can be determined with a single measurement. The further measurement plane can consist of the plurality of further subapertures, i.e., subsurfaces. This means that each of the further subapertures can be formed as a segment of the further measurement plane. Analogously, the further wavefront profile can be composed of the plurality of further partial wavefront profiles of the further subapertures.

Furthermore, the method can comprise a step of capturing a further optical wavefront profile in the further measurement plane and a step of ascertaining a further partial optical wavefront profile for each further subaperture of the plurality of further subapertures of the further measurement plane using the further wavefront profile. Advantageously, the further wavefront profile can also be captured by means of a wavefront sensor.

As an alternative to measuring, in a step of calculating, the at least one further wavefront profile in the further measurement plane can be calculated using the wavefront profile of the measurement plane. In addition, in a step of ascertaining, a further partial optical wavefront profile for each further subaperture of the plurality of further subapertures of the further measurement plane can be ascertained using the further wavefront profile. This means that the further wavefront profile can be deduced from already existing data regarding the wavefront profile.

According to one embodiment, in the step of calculating, the further wavefront profile in the second measurement plane can be calculated by means of a known ray tracing algorithm. The ray tracing algorithm can represent an algorithm, based on the emission of rays, for calculating their propagation path, by means of such an algorithm a spatial propagation of the light rays from a certain point in space can be ascertained. Advantageously, the algorithm can be implemented in advance so that it may, for example, use previously captured and additionally or alternatively ascertained data regarding the optical system to be tested to calculate the further wavefront profile. Alternatively, the step of calculating can take place on the mathematical basis of wave-optical models.

According to one embodiment, a size of the plurality of subapertures may differ from a size of the plurality of further subapertures. This means that the dimensions of the subapertures and of the further subapertures may differ from one another, for example. Furthermore, the measurement plane and, additionally or alternatively, the further measurement plane can be divided between multiple evaluation iterations.

Furthermore, a device for determining an imaging quality of an optical system to be tested is presented, wherein the device comprises a receiving unit for receiving the optical system to be tested, a further optical system for capturing an optical wavefront profile in a measurement plane behind an exit pupil of the optical system to be tested, and an evaluation unit for dividing the measurement plane into a plurality of subapertures, for ascertaining a partial optical wavefront profile for each subaperture of a plurality of subapertures of the measurement plane using the wavefront profile, and for determining a partial optical imaging quality for each of the subapertures using the ascertained partial optical wavefront profiles.

The device may, for example, be realized as a measuring device, which may, for example, be used in conjunction with a production or testing of optical systems, such as data glasses, or, in general, systems for the AR/VR sector. The receiving unit may, for example, be realized as a holder, such as a gripping arm or holding arm, or merely as a receiving region. The further optical system may, for example, be realized as a sensor unit, for example a wavefront sensor. The evaluation unit may also be referred to as a computing unit, which can be connected to the further optical system. The device can advantageously be formed to carry out an optical measurement technique such as an imaging quality characterization of, for example, AR/VR headsets, components of such headsets, or ophthalmic optical instruments. The described approach thus makes it possible to quickly virtually evaluate the imaging quality for multiple measurement positions and various apertures within an eye box, for example for AR/VR measurement technology and, in general, for measurement technology for ophthalmic optical systems, such as binoculars, eyeglasses, or corrective lenses. A characterization of so-called near-eye displays is also possible. Advantageously, the imaging quality can be determined for various positions of the eye pupil within the eye box. The device can advantageously be designed to do so by means of a one-shot measurement with only one measurement in the range between 1 and 3 seconds. This can advantageously reduce the complexity of the device and thus save costs.

According to one embodiment, the device may comprise a light source for illuminating the optical system to be tested, when the optical system to be tested is received by the receiving unit. The light source may, for example, be formed as a light-emitting diode (LED) or, for example, as a laser light source. The light source is designed to emit light and thereby to illuminate the optical system to be tested.

An additional optical system for collimating the light rays coming from the light source can be arranged downstream of the light source. The optical system for collimating the light rays coming from the light source can advantageously be realized as a projector unit, which may, for example, comprise at least one optical lens.

Furthermore, the further optical system can be pivotable at an angle with respect to an optical axis of the optical system to be tested. Due to the pivotability, the further optical system can advantageously be pivoted such that one or more partial imaging qualities can be determined in at least one off-axis field angle position.

According to one embodiment, the further optical system for capturing the optical wavefront profile may comprise a telescope and a Shack-Hartmann sensor. The telescope and the Shack-Hartmann sensor can advantageously be enclosed in a common housing and referred to as components of the further optical system. Within the housing, the components may, for example, be arranged fixedly, i.e., stationarily, relative to one another so that objects at a fixed distance from the housing are imaged onto the sensor.

Exemplary embodiments of the approach presented herein are shown in the drawings and explained in more detail in the following description. In the drawings:

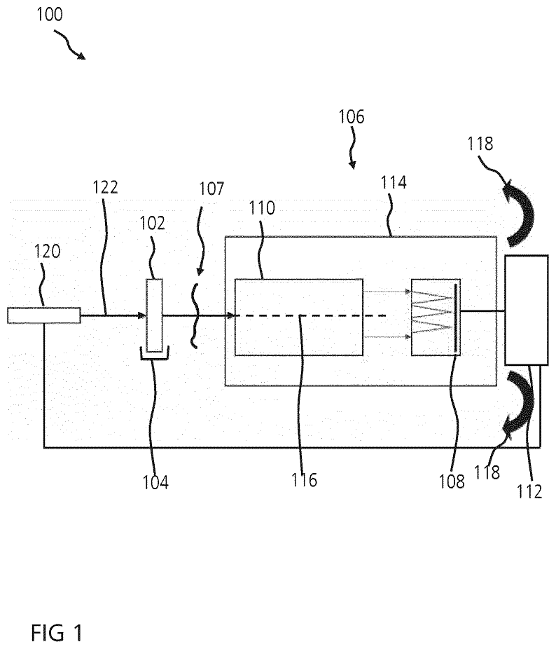

FIG. 1 shows a schematic representation of an exemplary embodiment of a device for determining an imaging quality of an optical system to be tested;

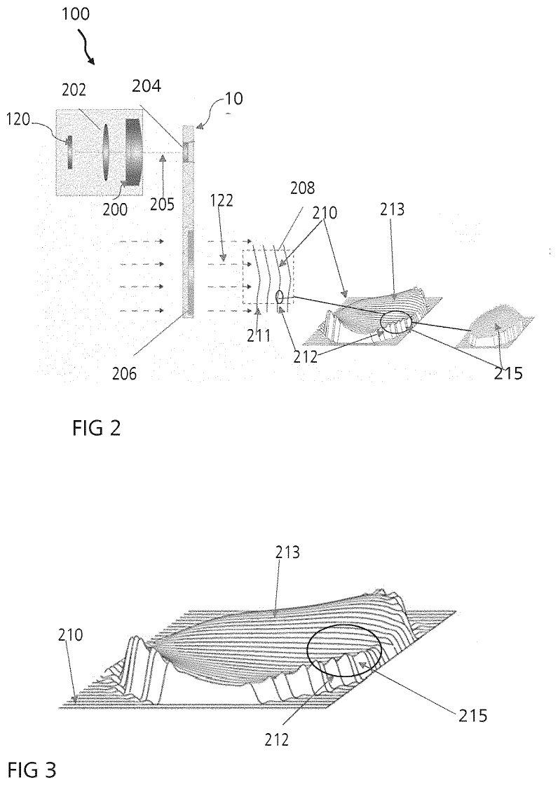

FIG. 2 shows a schematic representation of an exemplary embodiment of a device for determining an imaging quality of an optical system to be tested;

FIG. 3 shows a diagrammatic representation of an exemplary embodiment of a section of a measurement plane with a three-dimensional wavefront profile;

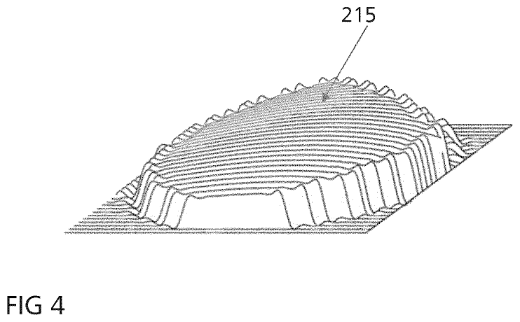

FIG. 4 shows a diagrammatic representation of an exemplary embodiment of a three-dimensional representation of a partial wavefront profile;

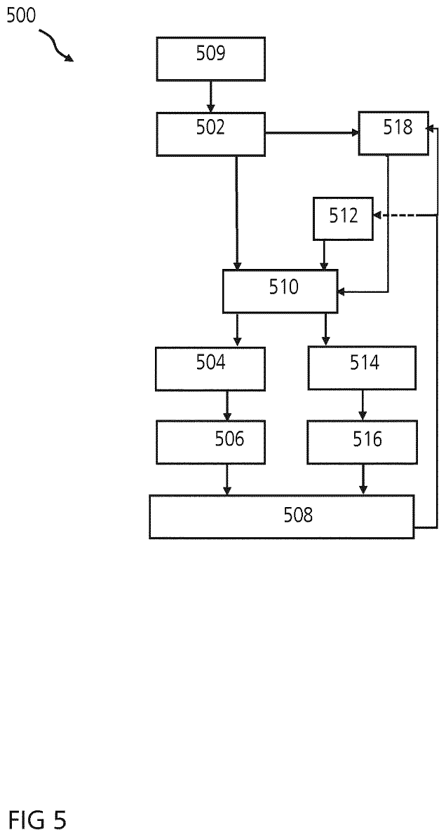

FIG. 5 shows a flowchart of an exemplary embodiment of a method for determining an imaging quality of an optical system to be tested;

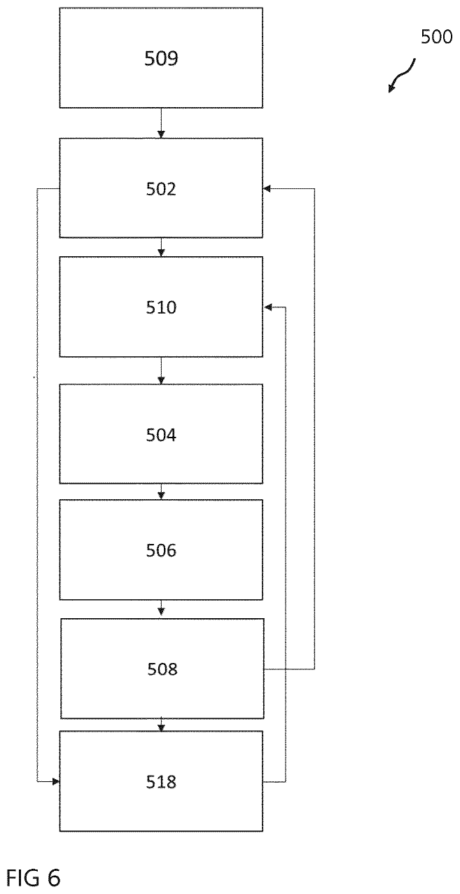

FIG. 6 shows a flowchart of an exemplary embodiment of a method for determining an imaging quality of an optical system to be tested;

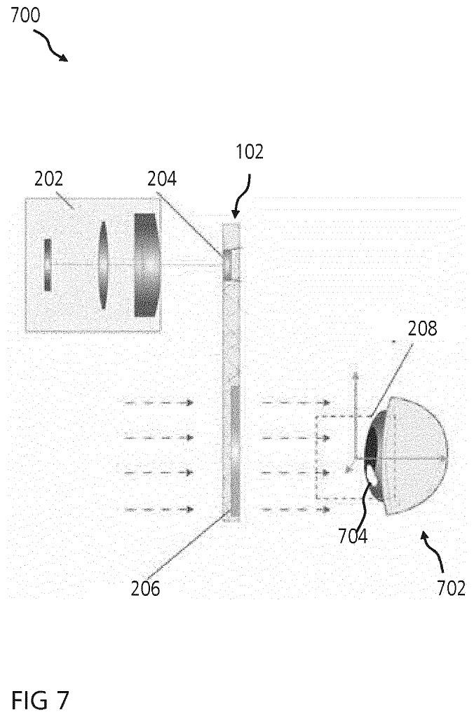

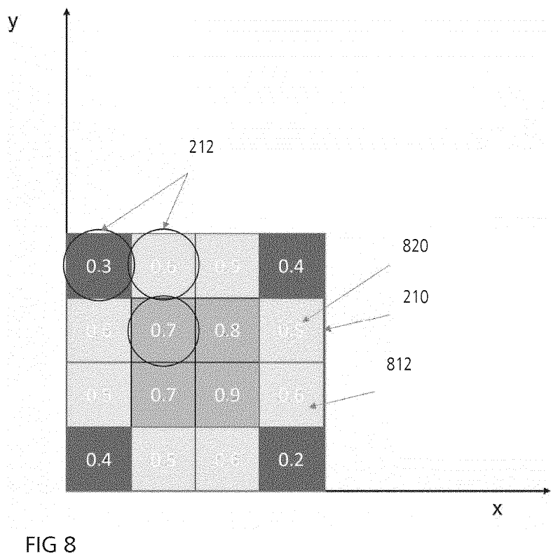

FIG. 7 shows a schematic representation of an operating arrangement of an optical system to be tested according to an exemplary embodiment; and

FIG. 8 shows a representation of a measurement plane according to an exemplary embodiment.

In the following description of advantageous embodiments of the present invention, the same or similar reference numerals are used for the elements that are shown in various figures and act similarly, whereby a repeated description of these elements is dispensed with.

FIG. 1 shows a schematic representation of an exemplary embodiment of a device 100 for determining an imaging quality of an optical system 102 to be tested. The device 100 may, for example, also be referred to as a measuring device or testing device. The optical system 102 is, for example, realized as an eyeglass lens, as a waveguide, or as another element that is, for example, used in conjunction with data glasses or, in the field of augmented reality (AR) or virtual reality (VR), as AR/VR glasses. The device 100 comprises a receiving unit 104 for receiving the optical system 102 to be tested. The shape of the receiving unit 104 is shown here merely by way of example. The receiving unit 104 may, for example, be realized as a gripping arm or holding arm, which furthermore optionally holds the optical system 102 at at least one system edge. The device 100 furthermore comprises a further optical system 106 for capturing an optical wavefront profile 107 in a measurement plane behind an exit pupil of the optical system 102 to be tested. The further optical system 106 may, for example, also be referred to as a sensor device since, according to this exemplary embodiment, it comprises a sensor unit 108 designed as a wavefront sensor or Shack-Hartmann sensor. Optionally, the optical system 106 according to this embodiment comprises a telescope 110. The device 100 furthermore comprises an evaluation unit 112, which is connected to the further optical system 106 and is designed to ascertain a partial optical wavefront profile for each subaperture of a plurality of subapertures of the measurement plane using the wavefront profile 107, furthermore to determine a partial optical imaging quality for each of the subapertures using the ascertained partial optical wavefront profiles, and thereby to make a statement about the spatial distribution of the imaging quality in the selected measurement plane using the partial imaging qualities. The evaluation unit 112 is accordingly also to be understood as a computing unit designed to control and/or carry out a method for determining the imaging quality for the optical system 102 to be tested. A corresponding method is described in more detail below with reference to FIGS. 5 to 6. According to an exemplary embodiment, the further optical system 106 additionally comprises a housing 114, which is designed to protect the telescope 110 and the sensor unit 108 from external influences. Merely optionally, the further optical system 106 is pivotable about an optical axis 116 of the optical system 102 to be tested, for example in at least two opposite directions 118.

The device 100 optionally comprises a light source 120, which is designed to illuminate the optical system 102 to be tested, when the optical system 102 to be tested is received by the receiving unit 104. For this purpose, the light source 120 according to this exemplary embodiment emits light rays 122 with predetermined light parameters toward the optical system 102 to be tested. The light rays 122 penetrate the optical system 102 to be tested and light rays exiting the optical system 102 to be tested again are captured by the sensor unit 108.

In other words, the approach presented herein deals with measuring the imaging quality of optical systems 102 that are worn close to the eye. In addition to eyeglass lenses, these optical systems in particular include waveguides in augmented or virtual reality (AR/VR) devices. In such applications, electronically generated images are projected into the field of vision of a viewer. For unrestricted perception by the user, sufficiently good imaging quality in the movement range of the eye is important. This range is referred to as the so-called eye box. The eye box is understood as a three-dimensional volume in which the pivot point of the eye must be located so that it is able to perceive the entire image exclusively through eye movements. According to this exemplary embodiment, the further optical system 106 is arranged in the region of the eye box.

The imaging quality within the eye box is an important quality parameter and can advantageously be checked by means of the approach presented herein. For example, the imaging quality, expressed by the modulation transfer function (MTF) and optionally by various further parameters, is measured at each eye position, more precisely at each pupil position, within the eye box. Merely optionally, the proposed approach makes it possible to fully check the entire volume enclosed by the eye box, which volume is understood as the measurement volume in the context of this approach. The measurement volume typically has an extent of 25×25×25 mm. On the basis of the measurement data ascertained with the wavefront sensor 108, further characteristic parameters, such as the intensity distribution within the eye box, can optionally also be ascertained.

According to an exemplary embodiment, the device 100 comprises the light source 120, which optionally has an optics for beam shaping, depending on whether the optical system 102, also referred to as the test object, is to be illuminated in a collimated or divergent manner. For example, in the case of afocal optical systems 102, such as waveguides for AR/VR glasses, collimated illumination of the optical system 102 is required. The further optical system 106, with the help of which the wavefront profile 107 is measured, is located behind the optical system 102, which is fastened in a suitable holder, the receiving unit 104. In the example shown here, this further optical system optionally comprises a Shack-Hartmann sensor as a sensor unit 108 with telescope 110. According to this exemplary embodiment, the telescope 110 is designed to adjust the beam cross-section such that the detection surface of the sensor unit 108 is sufficiently illuminated. The detection surface of a Shack-Hartmann sensor typically has dimensions in the range of 7×7 mm to 15×15 mm. The telescope 110 and the sensor unit 108 are installed, by way of example, in the common housing 114. According to this exemplary embodiment, the evaluation of the measurement results takes place in the evaluation unit 112, referred to as the computing unit, such as a PC. Furthermore, the housing 114 and thus the further optical system 106 is pivotable by a defined angle so that the wavefront profile 107 can also be measured for field angles greater than 0°. Instead of a Shack-Hartmann sensor, the sensor unit 108 may also be realized as a wavefront sensor based on a different measuring principle.

FIG. 2 shows a schematic representation of an exemplary embodiment of a device 100 for determining an imaging quality of an optical system 102 to be tested. The device 100 shown here is similar to the device 100 described in FIG. 1. According to this exemplary embodiment, an additional optical system 200 for collimating the light rays coming from the light source 120 is arranged downstream of the light source 120. The additional optical system 200 comprises, for example, one or more lenses for guiding light. The light source 120 and the additional optical system 200 are, for example, realized as a whole as a projector unit 202.

According to this exemplary embodiment, light coming from the projector unit 202 impinges on an entrance pupil 204 of the optical system 102 to be tested that lies on a common axis 205. The optical system 102 furthermore comprises an exit pupil 206, via which collimated light rays 122 are finally emitted toward the eye box 208, within which wavefront profiles of the light rays are captured on multiple measurement planes, for example a measurement plane 210, and at least one further measurement plane 211. By way of example, according to this exemplary embodiment, four measurement planes 210, 211 are shown, which are arranged at regular distances from one another and can each have a curvature. Furthermore, the recording of a wavefront profile 213 for the entire measurement plane 210 is shown by way of example. In addition, the recording of a partial wavefront profile 215 is shown.

In FIG. 2, a section 212 from an eye box 208 is also marked, which is described in more detail with reference to a diagrammatic representation in at least one of the figures described below. For example, the section 212 represents a particular eye position and subaperture.

FIG. 3 shows a diagrammatic representation of an exemplary embodiment of a wavefront profile 213 in a measurement plane 210. The wavefront shown here corresponds, for example, to the wavefront (mentioned in FIG. 2) within the measurement plane 210 and accordingly shows a result of a wavefront measurement over the entire measurement plane 210. The wavefront profile 213 of the measurement plane 210 includes a subaperture 212 of the measurement plane 210 within the eye box 208, using the example of waveguides for AR applications, for example. The subaperture 212 has, for example, a partial wavefront profile 215, which is shown by way of example in a diagram in the following figure.

According to this exemplary embodiment, the wavefront profile 213 in the measurement plane 210 is shown as a three-dimensional plot in an xyz diagram, with the axes omitted for improved visibility. The eye box itself usually has dimensions of, for example, 25×25×25 mm.

FIG. 4 shows a diagrammatic representation of an exemplary embodiment of a partial wavefront profile 215. The partial wavefront profile 215 corresponds, for example, to the partial wavefront profile 215 (mentioned in FIG. 3) from the subaperture 212 and is merely shown enlarged. For example, the partial wavefront profile 215 corresponds to the usual dimensions of 3 mm diameter for positioning the eye pupil in the eye box. The imaging quality for such a region is determined by the method as described in at least one of FIGS. 5 to 6. Since the entire wavefront profile 213 in the measurement plane 210 is known, partial wavefront profiles can be determined for any number of subapertures 212, whereby a virtual scan in the x,y direction is carried out. A virtual z-positioning is calculated, for example, via ray tracing. A measurement time is, for example, between 1 and 3 seconds and requires, merely by way of example, a relatively simple measuring device.

FIG. 5 shows a flowchart of an exemplary embodiment of a method 500 for determining an imaging quality of an optical system to be tested. The method 500 is, for example, carried out using a device as described, for example, in at least one of FIGS. 1 to 2. The method 500 comprises a step 502 of capturing an optical wavefront profile in a measurement plane behind an exit pupil of the optical system, a step 504 of ascertaining a partial optical wavefront profile for each subaperture of a plurality of subapertures of the measurement plane using the wavefront profile, a step 506 of determining a partial optical imaging quality for each of the subapertures using the ascertained partial optical wavefront profiles, and an optional step 508 of determining the distribution of the imaging quality in the measurement plane using the partial imaging qualities, as shown, merely by way of example, in at least one of FIGS. 3 to 4. The method 500 furthermore comprises a step 510 of dividing the measurement plane into the plurality of subapertures. According to this exemplary embodiment, the step 510 of dividing is carried out before the step 504 of ascertaining. For example, a size of the plurality of subapertures differs from a size of a plurality of optional further subapertures of a further measurement plane.

According to this exemplary embodiment, the wavefront profile in the measurement plane is captured, in the step 502 of capturing, using a wavefront sensor. In the step 504 of ascertaining, an individual partial wavefront profile is furthermore ascertained for each subaperture from the plurality of subapertures with the aid of the wavefront profile in the measurement plane so that, in the step 506 of determining, the partial imaging quality is determined for each of the subapertures using the ascertained partial wavefront profile respectively assigned thereto.

Optionally, the method 500 additionally comprises further steps, such as a step 509 of defining, which is carried out before the step 502 of capturing and in which a measurement volume is defined. The measurement plane represents, for example, a cross-sectional area of the measurement volume.

According to an exemplary embodiment, the method 500 furthermore comprises a step 512 of capturing a further optical wavefront profile in the further measurement plane, for example using a further wavefront sensor or using the wavefront sensor used to capture the first wavefront. In a step 514 of ascertaining, a further partial optical wavefront profile for each further subaperture of the plurality of further subapertures of the further measurement plane is ascertained using the further wavefront profile. Beforehand, the step 510 of dividing is likewise applied to the further measurement plane.

According to this exemplary embodiment, the method 500 comprises a step 516 of determining a further partial optical imaging quality for each further subaperture of the plurality of further subapertures of the further measurement plane behind the exit pupil of the optical system so that, in the optional step 508 of determining, the distribution of the imaging quality is determined computationally using the further partial imaging qualities. The measurement plane and the further measurement plane are linearly spaced apart along an optical axis of the optical system, whereby the calculated partial imaging qualities are distributed within a volume.

Furthermore optionally, the method 500 comprises a step 518 of calculating the further wavefront profile in the further measurement plane using the wavefront profile of the measurement plane. The step 518 of calculating is to be understood as a design variant or in addition to the step 512 of capturing the further optical wavefront profile. According to this exemplary embodiment, the second wavefront profile in the second measurement plane is calculated, for example, with the help of a ray tracing algorithm. If the step 518 of calculating is carried out, ascertaining takes place for each further subaperture of the plurality of further subapertures of the further measurement plane using the calculated further wavefront profile in the step 514 of ascertaining the further partial optical wavefront profile.

In a corresponding manner, further wavefront profiles for even further measurement planes can be ascertained and used to determine the imaging quality.

FIG. 6 shows a flowchart of an exemplary embodiment of a method 500 for determining an imaging quality of an optical system to be tested. The method 500 corresponds, for example, to the method 500 described in FIG. 5 and differs merely in the representation of the flowchart. According to this exemplary embodiment as well, the method 500 comprises the step 509 of defining for defining the measurement volume before the step 502 of capturing as well as the step 510 of dividing the measurement plane into the plurality of subapertures before the step 504 of ascertaining. According to this exemplary embodiment, individual steps can be carried out repeatedly so that, for example, after the step 508 of determining the distribution of the imaging quality using the previously determined partial imaging qualities, the step 502 of capturing is carried out again for a further measurement plane.

Alternatively, the further wavefront profile in the further measurement plane is calculated in step 518 using the wavefront profile of the measurement plane, and the imaging quality in the further measurement plane is thus determined using previously captured data.

In other words, in a first method step 502, the profile of the optical wavefront is measured in a first measurement plane, which lies behind the exit pupil of the optical system to be tested. By way of example, the use of a Shack-Hartmann wavefront sensor should be mentioned at this point. Of course, further methods, such as interferometric methods, for optical wavefront measurement are conceivable. For this purpose, the measurement plane comprises, for example, the size of a cross-section of the entire exit pupil, or the eye box, of the test object or a section thereof. Optionally, the desired measurement volume is defined in the preparatory step 509.

In the next step 510, the measurement plane is divided into a multitude of small subapertures or subsurfaces. The extent of the individual subapertures is in the order of magnitude of a human eye pupil, i.e., for example, 2.5 mm in diameter. This setting can also be optionally adjusted in a preparatory step. In other words, the entire wavefront of the measurement plane is divided or segmented into a multitude of partial wavefronts in the step 510 of dividing. Subsequently, the wavefront profile for each of the individual subapertures is ascertained from the wavefront profile of the entire measurement plane in the step 504 of ascertaining. For example, a local parameter for the local imaging quality of the test object within the subaperture is determined from each of the partial wavefronts in the step 506 of determining. Such a parameter is, for example, the modulation transfer function (MTF) or an aberration, such as a coma or astigmatism.

Since the imaging quality for each subaperture within the measurement plane is now known, a statement can be made in a further step 508 about how the imaging quality parameter (e.g., the MTF) is distributed across the measurement plane. For example, a statement can be made about the eye positions at which the MTF exceeds or falls below a specified threshold value. This makes a detailed evaluation of the MTF distribution in the measurement plane possible without having to explicitly measure the wavefront at every possible eye position, whereby the overall measurement time can be reduced. For this purpose, a corresponding threshold value comparison may, for example, be carried out in step 508.

In order to determine the imaging quality in the entire measurement volume, according to this exemplary embodiment, the course of the optical wavefront along the optical axis of the test object is ascertained in the following method step 518. More precisely, the profile of the wavefront is computationally ascertained in at least one further measurement plane located at a defined distance z from the first measurement plane, which is carried out in FIG. 5 in the optional step of calculating. The calculation of the wavefront profile is, for example, achieved with the help of ray tracing algorithms when the profile of the wavefront has been measured at a first z-position. According to this exemplary embodiment, the imaging quality for each pupil position of the eye is likewise determined from the computationally determined wavefront. This step 518 is repeatable for any number of planes in the entire measurement volume.

Alternatively, optionally after completion of the step 508 of determining the distribution of the imaging quality in a measurement plane, the wavefront profile is measured in a further measurement plane by repeating the step 502 of capturing for the further measurement plane, for example by moving the wavefront sensor along the z-axis. The step 502 can also be repeated for any number of measurement planes. In principle, a combination of the steps 502, 518 is also possible.

FIG. 7 shows a schematic representation of an operating arrangement 700 of an optical system 102 to be tested according to an exemplary embodiment. The optical system 102 corresponds, for example, to the optical system 102 described in one of FIG. 1 or 2, and is arranged according to this exemplary embodiment in an operational state. According to this exemplary embodiment, the projector unit 202 is directed toward the optical system 102, wherein the projector unit 202 is at least similar to the projector unit 202 described in FIG. 2. The operating arrangement 700 shown here also corresponds to the structure (described in FIG. 2) of the device. According to this exemplary embodiment, merely one eye 702 of a viewer is shown, whose eye pupil 704 is schematically positioned in the region of the three-dimensional eye box 208 in a schematic representation of waveguides for AR applications.

FIG. 8 shows a representation of a measurement plane 210 according to an exemplary embodiment. The measurement plane 210 is plotted in a diagram with an x-axis and a y-axis, each of which indicates a spatial extent of the measurement plane 210 in millimeters. The measurement plane 210 represents a cross-section of the eye box. By way of example, the measurement plane 210 is shown as square and is divided into a plurality of 16 square segments 812 by way of example. Each of the segments 812 corresponds to an eye position. A subaperture 212 exists for each of the segments 812. Adjacent subapertures 212 may have an overlap region. Each subaperture 212 and thus each eye position is assigned an MTF value as a partial imaging quality 820 by way of example. For example, the subapertures 212 shown have MTF values between 0.2 and 0.9.

1. A method for determining an imaging quality of an optical system to be tested, the method comprising:
capturing an optical wavefront profile in a measurement plane behind an exit pupil of the optical system;
dividing the measurement plane into a plurality of subapertures;
ascertaining a partial optical wavefront profile for each subaperture of the plurality of subapertures of the measurement plane using the wavefront profile; and
determining a partial optical imaging quality for each of the subapertures using the ascertained partial optical wavefront profiles.

2. The method according to claim 1, wherein, in the step of capturing, the wavefront profile in the measurement plane is captured using a wavefront sensor.

3. The method according to claim 1, further comprising: defining a measurement volume before the step of capturing, wherein the measurement plane represents a cross-sectional area of the measurement volume.

4. The method according to claim 1, further comprising:
capturing a further optical wavefront profile in a further measurement plane; and
ascertaining a further partial optical wavefront profile for each further subaperture of a plurality of further subapertures of the further measurement plane using the further wavefront profile.

5. A method according to claim 1, further comprising: with a step of
calculating at least one further wavefront profile in a further measurement plane using the wavefront profile of the measurement plane; and
ascertaining a further partial optical wavefront profile for each further subaperture of a plurality of further subapertures of the further measurement plane using the further wavefront profile.

6. The method according to claim 4, further comprising: determining a further partial optical imaging quality for each further subaperture of the plurality of further subapertures of the further measurement plane behind the exit pupil of the optical system

7. The method according to claim 5, wherein, in the step of calculating, the further wavefront profile in the further measurement plane is calculated using a ray tracing algorithm.

8. The method according to claim 4, wherein a size of the plurality of subapertures differs from a size of the plurality of further subapertures.

9. A device for determining an imaging quality of an optical system to be tested, the device comprising:
a receiving unit for receiving the optical system to be tested;
a further optical system for capturing an optical wavefront profile in a measurement plane behind an exit pupil of the optical system to be tested; and
an evaluation unit for dividing the measurement plane into a plurality of subapertures, for ascertaining a partial optical wavefront profile for each subaperture of the plurality of subapertures of the measurement plane using the wavefront profile, and for determining a partial optical imaging quality for each of the subapertures using the ascertained partial optical wavefront profiles.

10. The device according to claim 9, further comprising a light source for illuminating the optical system to be tested, when the optical system to be tested is received by the receiving unit.

11. The device according to claim 10, wherein an additional optical system for collimating the light rays coming from the light source is arranged downstream of the light source.

12. The device according to claim 9, wherein the further optical system is pivotable at an angle with respect to an optical axis of the optical system to be tested.

13. The device according to claim 9, wherein the further optical system for capturing the optical wavefront profile comprises a telescope and a Shack-Hartmann sensor.
